(19) United States
(12) Patent Application Publication
(10) Pub. No.: US 2013/0238223 A1
(43) Pub. Date: Sep. 12, 2013

(54) METHOD AND DEVICE FOR RECOGNIZING PRE-IGNITIONS IN A GASOLINE ENGINE

(71) Applicants: Wolfgang FISCHER, Gerlingen (DE); Carsten KLUTH, Stuttgart (DE); Werner HAEMING, Neudenau (DE); Li LUO, Stuttgart (DE)

(72) Inventors: Wolfgang FISCHER, Gerlingen (DE); Carsten KLUTH, Stuttgart (DE); Werner HAEMING, Neudenau (DE); Li LUO, Stuttgart (DE)

(73) Assignee: ROBERT BOSCH GMBH, Stuttgart (DE)

(21) Appl. No.: 13/785,900

(22) Filed: Mar. 5, 2013

(30) Foreign Application Priority Data
Mar. 6, 2012 (DE) 10 2012 203 487.0

(51) Int. Cl. F02D 41/14

(52) U.S. Cl. CPC F02D 41/1438
USPC 701/111

(57) ABSTRACT

A method for recognizing pre-ignitions in a gasoline engine which occur in the combustion chamber of the gasoline engine, independently of the ignition of a fuel-air mixture by a spark plug. In a method which reliably recognizes the formation of sporadically imminent pre-ignitions, a combustion chamber pressure which occurs prior or subsequent to the ignition point of the spark plug is evaluated for determining the pre-ignition.

### CROSS REFERENCE

The present application claims the benefit under 35 U.S.C. §119 of German Patent Application No. DE 102012203487.0 filed on Mar. 6, 2012, which is expressly incorporated herein by reference in its entirety.

### FIELD

The present invention relates to a method for recognizing pre-ignitions in a gasoline engine which occur in the combustion chamber of the gasoline engine, independently of the ignition of a fuel-air mixture by a spark plug, and a device for recognizing pre-ignitions in a gasoline engine.

### BACKGROUND INFORMATION

In a gasoline engine, the vehicle is set in driving operation or the driving operation is maintained as the result of combustion of the supplied fuel-air mixture. In the development of recent gasoline engines, there has been a tendency toward downsizing the gasoline engines in combination with direct injection and supercharging. Supercharging allows a reduction in the displacement of the gasoline engine without lowering the power level, thus achieving appropriate downsizing of the gasoline engine. Thus, under partial load the gasoline engine may be operated at higher loads with higher part-load efficiency, and the fuel consumption may be reduced. However, the increase in charge pressure for improving the efficiency of the gasoline engine is limited by the phenomenon of pre-ignitions. Pre-ignitions also occur in naturally aspirated engines, which have a very high compression ratio; these pre-ignitions must be recognized.

Pre-ignitions occur sporadically in the combustion chamber of the gasoline engine, independently of the ignition of a fuel-air mixture by a spark plug. The increase in charge pressure for improving the efficiency results in very high thermal stress on the combustion chambers of the gasoline engine. This results in pre-ignition, which arises when individual components in the combustion chamber of the gasoline engine reach excessively high temperatures, and the fuel-air mixture is thus ignited in an uncontrolled manner.

Pre-ignition is usually recognized via the knock sensor signal or via the rotational speed signal of the crankshaft. Knock sensors or rotational speed sensors are usually installed at the gasoline engine; however, the recognition quality of the pre-ignition by these sensors, in particular in the range of the recognition threshold, is not particularly high. In addition, significant interference couplings are present for the signals of the knock sensors and the rotational speed sensors.

### SUMMARY

An object of the present invention is to provide a method for recognizing pre-ignitions, in which reliable recognition in the combustion chamber of the gasoline engine is ensured.

According to an example embodiment of the present invention, a combustion chamber pressure which occurs prior or subsequent to the ignition point of the spark plug is evaluated for determining the pre-ignition. The evaluation of the pressure signal directly from the combustion chamber of the gasoline engine allows the pre-ignitions to be recognized much more efficiently, since interference couplings are reduced. In addition, the evaluation of the combustion chamber pressure signal allows the pre-ignitions to be reliably recognized in all cylinders of the gasoline engine over the entire rotational speed range of the gasoline engine. The gasoline engine may be designed with even more optimal efficiency due to this much more efficient recognition of the pre-ignitions. At the same time, protection of the gasoline engine from engine damage is increased.

A direct evaluation of the combustion chamber pressure is advantageously carried out by determining and evaluating a maximum pressure amplitude and/or a position of the maximum pressure amplitude over a crankshaft angle and/or a predefined period of time. The “maximum pressure amplitude” is understood to mean the maximum pressure or the peak pressure of the absolute signal delivered by the combustion chamber pressure sensor. Application within the engine control system of a motor vehicle is simplified significantly by evaluating these features. Very long application times are dispensed with, since a correlation between the combustion chamber pressure and structure-borne noise or rotational speed is not necessary. In addition, the intensity of the pre-ignition is reliably derivable from the pressure signal.

In one example embodiment, energy released for each degree of the crankshaft angle due to the combustion is derived from the combustion chamber pressure and evaluated. Thus, reliable recognition of pre-ignitions based on the signals derived from the combustion chamber pressure is also possible with little application effort. In determining the pre-ignition, use is made of the fact that for a pre-ignition, in contrast to a normal combustion the pre-ignition takes place significantly earlier in the same operating point.

In one refinement, the energy released during the combustion is derived from the combustion chamber pressure and evaluated. This energy is normally referred to as the cumulative heat-release rate, while the energy released during the combustion, based on the combustion chamber pressure for each degree of the crankshaft angle, is referred to as the heat-release rate. The heat-release rate as well as the cumulative heat-release rate are particularly suited for recognizing pre-ignitions based on the combustion chamber pressure, with the aid of a control unit.

In one variant, for recognizing the pre-ignition, a preferably filtered, high-frequency combustion chamber pressure signal of a cylinder of the gasoline engine is evaluated beginning at a predefined crankshaft angle at which pre-ignitions are expected, and an energy derived from the high-frequency combustion chamber pressure signal is determined, a pre-ignition being recognized if the energy of the combustion chamber pressure signal exceeds the predefined first threshold value. To generate a high-frequency combustion chamber pressure signal, a bandpass filter having a passband of 4 kHz to 30 kHz, for example, is placed upstream from the combustion chamber pressure signal. As soon as the signal energy prior to the expected start of the normal combustion exceeds a certain value, pre-ignition is deduced. Various methods for computing signal energy may be used, such as rectification and summation or squaring and summation. Alternatively, the absolute value of the maximum pressure amplitude may be considered. This is preferably carried out based on time-based sampling of the pressure signal.

In one variant, a combustion chamber pressure compression curve over the crankshaft angle is compared to a measured combustion chamber pressure curve over the crankshaft angle and evaluated with regard to a pre-ignition. The combustion chamber pressure compression curve is modeled based on a known charge pressure and/or the charging known from the charging estimation, in particular the compression phase and the expansion phase of a piston stroke in a cylinder of the gasoline engine being considered. A pre-ignition may be easily deduced via such a threshold value approach. In addition, the application times are reduced with the aid of such a threshold value approach.

The combustion chamber pressure curve which is measured over the crankshaft angle is advantageously divided by the combustion chamber pressure compression curve which is modeled over the crankshaft angle, a quotient curve with regard to the pre-ignition being evaluated, and in particular a pre-ignition being recognized if the quotient curve is greater than a second threshold value in a range of the quotient curve where combustion is not yet expected. In this regard, “compression” is to be understood as the pressure that is measured in the compression phase and also in the expansion phase of the piston stroke of the cylinder of the gasoline engine. In particular, the measured combustion chamber pressure curve is still smoothed beforehand, so that no error recognitions are triggered due to high-frequency interferences.

Alternatively, a first curve of p (φ)*dV (φ) is ascertained from the estimated combustion chamber pressure compression curve, and is compared to a second p (φ)*dV (φ) curve that is ascertained from the measured combustion chamber pressure curve, the second p (φ)*dV (φ) curve being divided by the first p (φ)*dV (φ) curve, and the p (φ)*dV (φ) quotient curve being evaluated with regard to pre-ignition, and in particular a pre-ignition being recognized if the p (φ)*dV (φ) quotient curve is greater than a third threshold value in a range of the p (φ)*dV (φ) quotient curve where combustion is not yet expected. The combustion chamber pressure is advantageously smoothed prior to the p (φ)*dV (φ) computation.

In another embodiment, for crankshaft angle φ2 the p (φ)*dV (φ) integrals are continuously compared in each case, and a pre-ignition is deduced in the event of an excessively large deviation. Crankshaft angle φ1 is advantageously selected in a range of 180 to 90 degrees before top dead center of the high-pressure loop.

In one specific embodiment, a multistage recognition of the pre-ignition is carried out in which multiple pre-ignition thresholds are compared to a variable that is used for recognizing the pre-ignition, and, in particular depending on the stage of recognition of the pre-ignition, at least one suitable countermeasure against the occurrence of the pre-ignition is selected. As the result of a multistage evaluation of the pre-ignition recognition, a distinction may be made between suspected pre-ignitions and a pre-ignition that is actually imminent. Measures may thus be initiated very early to prevent pre-ignitions.

In one variant, the pre-ignition is recognized based on a comparison of the variable used for recognizing the pre-ignition to the corresponding variables from n preceding combustions assessed as normal combustion. The recognition of an imminent pre-ignition is simplified by the comparison to multiple combustions classified as normal combustion.

One refinement of the present invention relates to a device for recognizing pre-ignitions in a gasoline engine which occur in the combustion chamber of the gasoline engine, independently of the ignition of a fuel-air mixture by a spark plug. To achieve a particularly accurate and reliable recognition of the pre-ignitions, elements are present which receive a signal from one pressure sensor in each case which detects a combustion chamber pressure in the combustion chamber of a cylinder of the gasoline engine, and recognize a pre-ignition as a function of the signal delivered by the pressure sensor, in particular a combustion chamber pressure which occurs prior or subsequent to the ignition point of the spark plug being evaluated for determining the pre-ignition. This has the advantage that in implementing a higher degree of downsizing of the gasoline engine, even better efficiencies of this gasoline engine may be achieved without the gasoline engine being exposed to destruction.

These elements advantageously include a signal detection unit and a signal evaluation device, the signal evaluation device initiating countermeasures against the recognized pre-ignition. As a result of this countermeasure, the power of the gasoline engine is reduced in order to also reduce the temperatures occurring in the gasoline engine. Such countermeasures may be, for example, a reduction in charging, an enrichment or leaning of the fuel-air mixture, a camshaft adjustment, and an injection shutoff.

The present invention allows numerous specific embodiments, one of which is explained in greater detail with reference to the figures.

### BRIEF DESCRIPTION OF THE DRAWINGS

FIG. 1 shows a device for determining a pre-ignition in a gasoline engine.

FIG. 2 shows various curves of the combustion chamber pressure in a cylinder of a gasoline engine.

### DETAILED DESCRIPTION OF EXAMPLE EMBODIMENTS

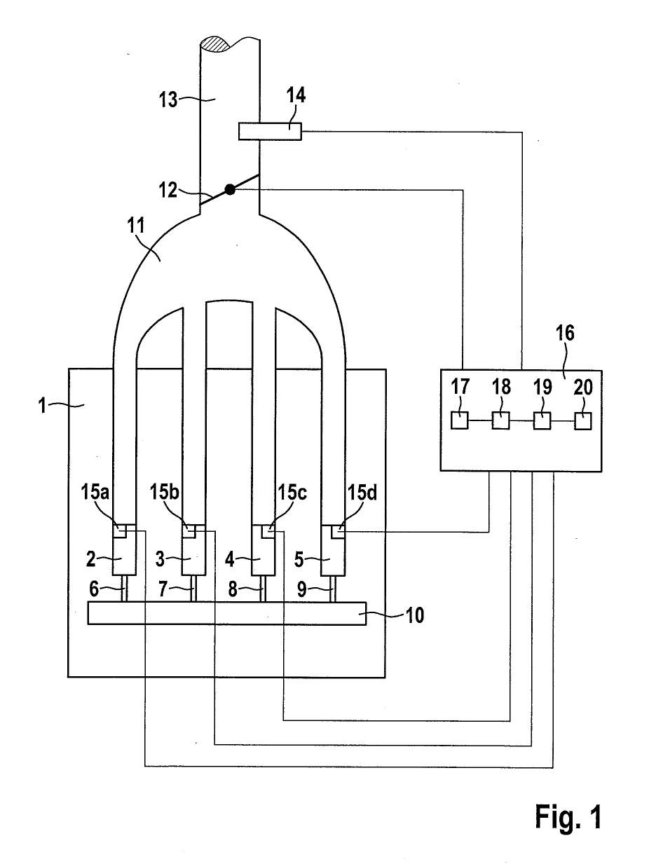

FIG. 1 shows a device for determining a sporadic pre-ignition in a gasoline engine 1. Gasoline engine 1 is designed as a naturally aspirated engine, and in this example has four cylinders 2, 3, 4, 5 whose pistons, not illustrated in greater detail, which move in cylinders 2, 3, 4, 5, are each connected to crankshaft 10 via a connecting rod 6, 7, 8, 9, respectively, and drive the crankshaft due to pressure changes caused by the combustions. Cylinders 2, 3, 4, 5 are connected to an intake manifold 11, which is closed off with respect to an air intake pipe 13 by a throttle valve 12. A nozzle 14 for injecting fuel, thus forming a fuel-air mixture, protrudes into air intake pipe 13. Alternatively, gasoline engine 1, in particular a downsizing engine, may be equipped with direct injection which directly and separately injects the fuel into the combustion chamber of gasoline engine 1 with the aid of an injector for each cylinder. Furthermore, an important feature is the supercharging, which is generally composed of a turbocharger (not illustrated in greater detail), but which may also have a two-stage design.

A pressure sensor 15a, 15b, 15c, 15d is situated in the combustion chamber of gasoline engine 1, i.e., in cylinders 2, 3, 4, 5, respectively, each pressure sensor being connected to a control unit 16. Control unit 16 is connected to throttle valve 12 and fuel injector nozzle 14.

When throttle valve 12 is open, the fuel-air mixture flows into intake manifold 11 and thus into cylinders 2, 3, 4, 5. A spark triggered by a spark plug, not illustrated in greater detail, initiates a normal combustion in cylinders 2, 3, 4, 5 in succession, causing a pressure rise in cylinder 2, 3, 4, 5 which is transmitted via the piston and connecting rod 6, 7, 8, 9 to the crankshaft, setting the crankshaft and thus also gasoline engine 1 in motion. In addition to this controlled normal combustion, combustions, referred to below as pre-ignition, sporadically occur which have combustion positions which may be present either prior or subsequent to the combustions of the normal ignition, and thus prior or subsequent to the ignition point of the normal ignition.

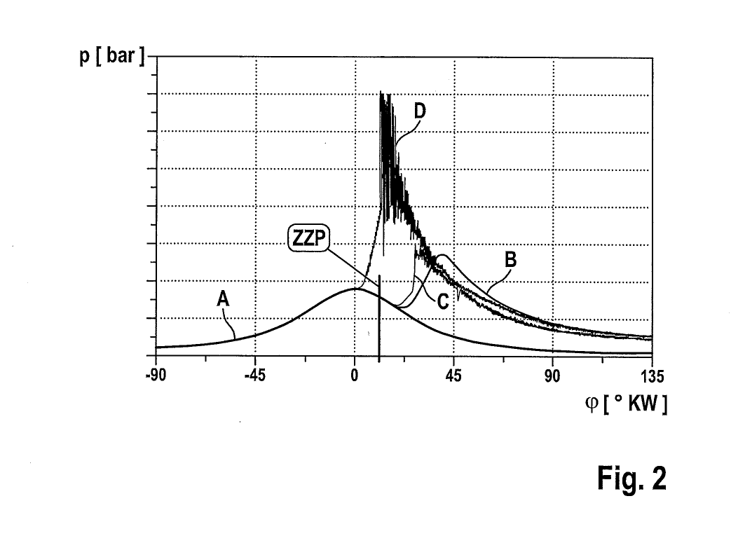

FIG. 2 illustrates different pressure curves which may occur during the combustion process in a cylinder 2, 3, 4, 5 of gasoline engine 1. Pressure p is illustrated as a function of crankshaft angle φ. Curve A shows a pressure curve that results during a compression of the fuel-air mixture in a cylinder, without combustion taking place. Such a pressure curve is very symmetrical over crankshaft angle φ, and is symmetrical with respect to top dead center. Second curve B shows a compression of the combustion chamber pressure that occurs during a normal combustion. The maximum pressure occurs subsequent to ignition point ZZP of the spark plug and a delay time in the cylinder. The combustion chamber pressure subsequently drops gradually and continuously over crankshaft angle φ. Curve C illustrates a knocking combustion without pre-ignition, in which the pressure fluctuations likewise occur subsequent to ignition point ZZP after the ignition by the spark plug. Curve D illustrates a pre-ignition in the combustion chamber of cylinder 2, 3, 4, 5 of gasoline engine 1, the maximum amplitude of which far exceeds the pressure conditions in pressure curves A, B, C; due to these pressure conditions, the temperatures are increased, which may potentially cause damage to gasoline engine 1.

Pre-ignitions as illustrated in curve D occur sporadically or in series, and should be recognized with the aid of the variables described below. A basic feature of the present approach is that pressure sensors 15a, 15b, 15c, 15d measure the combustion chamber pressure directly in the combustion chambers of cylinders 2, 3, 4, 5, respectively. These measuring results are relayed to control unit 16, which has a signal detection unit 17 for recognizing the pre-ignitions and receives the signals of pressure sensors 15a, 15b, 15c, 15d. Signal detection unit 17 relays these received signals to a signal evaluation device 18 of control unit 16. Signal evaluation device 18 is connected to a pre-ignition recognition unit 19, which in turn is connected to a unit which generates countermeasures for the sporadic pre-ignition. These countermeasures may be a reduction in charging, an enrichment or leaning of the fuel-air mixture, a camshaft adjustment, or an injection shutoff. For this purpose, control unit 16 controls throttle valve 12 and/or injector 14. As a result of all of these measures the power of gasoline engine 1 is reduced, thus lowering the temperature in the combustion chamber of the gasoline engine, which counteracts a formation of pre-ignitions.

For recognizing pre-ignitions with the aid of the combustion chamber pressure measured by pressure sensors 15a, 15b, 15c, 15d, there is the option, on the one hand, to directly evaluate the combustion chamber pressure, or on the other hand, to carry out an indirect evaluation via variables derived from the combustion chamber pressure. In the direct evaluation of the combustion chamber pressure, pre-ignitions are recognized based on the maximum pressure amplitude and/or the position of the maximum pressure amplitude with respect to crankshaft angle φ. These two variables, may be considered separately as well as together in evaluating the pre-ignitions.

For the indirect recognition of the pre-ignitions based on the combustion chamber pressure, there is the option to examine signals derived from the combustion chamber pressure, as well as from the heat-release rate or the cumulative heat-release rate, for a pre-ignition. Use is made of the fact that in a pre-ignition, in contrast to a normal combustion, the pre-ignition takes place significantly earlier in the same operating point. The feature of the earlier initiation may be evaluated over crankshaft angle φ or over a certain period of time.

The heat-release rate describes in a simplified manner the energy released for each degree of the crankshaft angle due to the combustion, while the cumulative heat-release rate, also referred to as the integrated heat-release rate, describes the energy integrally released at a first crankshaft angle φ due to the combustion, beginning at an observed crankshaft angle φ or a time t. For the heat-release rate, the position of the maximum value and/or the position at which the heat-release rate has achieved a certain percentage, for example 50%, of the maximum value in the range prior to the maximum value or the range subsequent to the maximum value is evaluated. Alternatively, other percentage values, for example 10%, may be used. This also applies to the cumulative heat-release rate. Based on the maximum value of the cumulative heat-release rate, the position in degrees of the crankshaft angle at which 50% of the maximum value of the cumulative heat-release rate is achieved is determined. Here as well, other percentage values, for example 10% of the maximum value, may alternatively be used.

Another variable for recognizing the pre-ignition is based on the comparison of a combustion chamber pressure compression curve and the actually measured combustion chamber pressure curve. The combustion chamber pressure compression curve is modeled based on the known charge pressure and/or the charging known from the charging estimation. A range of the crankshaft angle from bottom dead center to top dead center of the piston in a cylinder 2, 3, 4, 5, or at least up to the ignition point of cylinder 2, 3, 4, 5, is always taken into account. For computing the variable determined for recognizing the pre-ignition, the measured combustion chamber pressure curve is then divided by the modeled combustion chamber pressure compression curve. It is advantageous to filter the combustion chamber pressure signal, which is delivered by pressure sensors 15a, 15b, 15c, 15d, prior to the evaluation in order to suppress interferences. The quotient curve resulting from this division is then evaluated by control unit 16 in a range where combustions are not yet expected. If the quotient is significantly greater than 1 in this range where combustions are not yet expected, it is recognized that pre-ignitions are imminent.

Alternatively, the PMI curve may be computed from the modeled combustion chamber pressure compression curve and compared to the PMI curve computed from the measured combustion chamber pressure curve. The term “PMI” refers to the indicated mean pressure. The PMI is computed from the normalized integral over the product of combustion chamber pressure p (φ) for a crank angle position (with a resolution of 1° crank angle, for example) and multiplied by the change in volume dV (φ) of the combustion chamber volume at crank angle position φ and the selected resolution.

$$PMI = normalization * {\int }_{ϕ 1}^{ϕ 2} p ( ϕ ) d V ( ϕ )$$

PMI is computed, as necessary, from a start angle φ1 to an end angle φ2. The normalization is 1/stroke volume.

The combustion chamber pressure curve documents the change in combustion chamber pressure p during a combustion. A first curve p (φ)*dV (φ) is ascertained from the estimated combustion chamber pressure compression curve, and is compared to a second p (φ)*dV (φ) curve which is ascertained from the measured combustion chamber pressure curve, the second p (φ)*dV (φ) curve being divided by the first p (φ)*dV (φ) curve, and the p (φ)*dV (φ) quotient curve being evaluated with regard to the pre-ignition and in particular a pre-ignition is recognized if the p (φ)*dV (φ) quotient curve is greater than 1 in a range of the p (φ)*dV (φ) quotient curve where no combustion is yet expected. The combustion chamber pressure is advantageously smoothed prior to the p (φ)*dV (φ) computation. There is also the option that for crankshaft angle φ2, the PMI integrals are continuously compared in each case, and a pre-ignition is deduced in the event of an excessively large deviation. Crankshaft angle φ1 is advantageously selected in a range of 180 to 90 degrees before top dead center of the high-pressure loop. As soon as the p (q)*dV (φ) quotient curve has a significant deviation of greater than 1 in a range where combustion is not yet expected, this combustion is recognized as an imminent pre-ignition.

Another option for recognizing pre-ignitions is to evaluate the high-frequency combustion chamber pressure signal of a cylinder 2, 3, 4, 5 based on the combustion chamber pressure signal delivered by pressure sensors 15a, 15b, 15c, 15d. The combustion chamber pressure signal is initially filtered, with the aid of a bandpass filter having a passband of 4 kHz to 30 kHz, and is observed beginning at a point in time (crankshaft angle φ or time t) after which pre-ignitions are theoretically able to start. As soon as the signal energy prior to the expected start of the combustion exceeds a certain value, a pre-ignition is deduced. The signal energy is computed by rectification and summation or by squaring and summation. Alternatively, however, for these high-frequency combustion chamber pressure signals the absolute value of the maximum or minimum pressure amplitude may be considered. This is preferably carried out based on time-based sampling of the combustion chamber pressure signal.

To increase the reliability in recognizing the pre-ignitions, the various variables used for recognizing pre-ignitions are compared to corresponding variables, such as pressure amplitude, heat-release rate, cumulative heat-release rate, etc., which have been determined in preceding combustions that have been classified as normal combustion. Based on such a comparison, the development of the pressure conditions in multiple successive combustions may be recognized, and a sporadically occurring pre-ignition may be reliably detected. Alternatively, the variables may be compared to the variables which occur in the same range of crankshaft angle φ or in a period of time t during normal combustions under the same operating conditions, i.e., at the same operating point. For these operating conditions, primarily the rotational speed, load, ignition angle, camshaft position, charge pressure, and temperature are to be considered. It is particularly advantageous to compare the variables at the same ignition angle with the aid of a threshold that is a function of the operating point.

The variables on the basis of which a pre-ignition is recognized are determined based on crankshaft-based sampling of the combustion chamber pressure. Alternatively, this variable determination may also be carried out based on time-based sampling of the combustion chamber pressure.

The evaluation of the combustion chamber pressure also allows a multistage recognition of the pre-ignitions. Thus, a first pre-ignition threshold is observed. If this first pre-ignition threshold is exceeded, this results in a suspected pre-ignition. Based on this suspected pre-ignition, first measures are then initiated to prevent subsequent pre-ignitions. If further, i.e., genuine, pre-ignitions occur anyway, which is detected by the exceedance of a second pre-ignition threshold, further countermeasures are initiated. Thus, in this example there are three categories: no pre-ignition, suspected pre-ignition, and pre-ignition that has been detected. These three categories are separated by pre-ignition threshold values of different magnitudes, the first pre-ignition threshold value which separates the categories of no pre-ignition and suspected pre-ignition being smaller than the second pre-ignition threshold value which separates the categories of suspected pre-ignition and pre-ignition. These measures ensure that no severe pre-ignitions occur that may result in destruction of gasoline engine 1.

The recognition of the pre-ignition based on the evaluation of the combustion chamber pressure has the advantage that the pre-ignitions are reliably recognized in all cylinders over the entire rotational speed range of gasoline engine 1. Thus, in the creation of the evaluation programs, application times are dispensed with, since a correlation between the combustion chamber pressure and structure-borne noise or rotational speed is not necessary. In addition, when a development stage is changed in the engine development, testing of the recognition software, or a new application, during the series development is dispensed with.

What is claimed is:

1. A method for recognizing pre-ignitions in a gasoline engine which occur in a combustion chamber of the gasoline engine, independently of ignition of a fuel-air mixture by a spark plug, the method comprising:
evaluating a combustion chamber pressure which occurs prior or subsequent to an ignition point of the spark plug; and
determining the pre-ignition as a function of the evaluation.

2. The method as recited in claim 1, wherein a direct evaluation of the combustion chamber pressure is carried out by determining and evaluating at least one of: i) a maximum pressure amplitude, and ii) a position of the maximum pressure amplitude, at least one of a crankshaft angle and a predefined period of time.

3. The method as recited in claim 1, wherein energy released for each degree of the crankshaft angle due to the combustion is derived from the combustion chamber pressure and evaluated.

4. The method as recited in claim 1, wherein energy released during the combustion is derived from the combustion chamber pressure and evaluated.

5. The method as recited in claim 3, wherein for recognizing the pre-ignition, a filtered, high-frequency combustion chamber pressure signal of a cylinder of the gasoline engine is evaluated beginning at a predefined crankshaft angle at which pre-ignitions are expected, and an energy is derived from the high-frequency combustion chamber pressure signal and evaluated in a suitable window, a pre-ignition being recognized if the energy of the high-frequency combustion chamber pressure signal exceeds a predefined first threshold value.

6. The method as recited in claim 1, wherein a combustion chamber pressure compression curve over the crankshaft angle is compared to a measured combustion chamber pressure curve over the crankshaft angle, and evaluated with regard to a pre-ignition.

7. The method as recited in claim 6, wherein the combustion chamber pressure curve which is measured over the crankshaft angle (φ) is divided by a combustion chamber pressure compression curve which is modeled over the crankshaft angle (φ), a quotient curve with regard to the pre-ignition being evaluated, and a pre-ignition being recognized if the quotient curve is greater than a second threshold value in a range of the quotient curve where combustion is not yet expected.

8. The method as recited in claim 7, wherein a first curve of p (φ)*dV (φ) is ascertained from the estimated combustion chamber pressure compression curve, and is compared to a second p (φ)*dV (φ) curve that is ascertained from the measured combustion chamber pressure curve, the second p (φ)*dV (φ) curve being divided by the first p (φ)*dV (φ) curve, and the p (φ)*dV (φ) quotient curve being evaluated with regard to pre-ignition, and in particular a pre-ignition being recognized if the p (φ)*dV (φ) quotient curve is greater than a third threshold value in a range of the p (φ)*dV (φ) quotient curve where combustion is not yet expected.

9. The method as recited in claim 1, wherein a multistage recognition of the pre-ignition is carried out in which multiple pre-ignition thresholds are compared to a variable that is used for recognizing the pre-ignition, and, depending on a stage of recognition of the pre-ignition, at least one suitable countermeasure against an occurrence of the pre-ignition is initiated.

10. The method as recited in claim 1, wherein the pre-ignition is recognized based on a comparison of a variable used for recognizing the pre-ignition to the corresponding variables from n preceding combustions assessed as normal combustion.

11. A device for recognizing pre-ignitions in a gasoline engine which occur in a combustion chamber of the gasoline engine, independently of ignition of a fuel-air mixture by a spark plug, comprising:
elements which receive a signal from one pressure sensor in each case which detects a combustion chamber pressure in the combustion chamber of a cylinder of the gasoline engine, and recognize a pre-ignition as a function of a signal delivered by the pressure sensor, wherein at least one of the elements is configured to evaluate the combustion chamber pressure which occurs prior or subsequent to an ignition point of the spark plug being evaluated for determining the pre-ignition.

12. The device as recited in claim 11, wherein the elements include a signal detection unit and a signal evaluation device, the signal evaluation device initiating countermeasures against the determined pre-ignition.
